(19) United States
(12) Patent Application Publication
(10) Pub. No.: US 2026/0050793 A1
(43) Pub. Date: Feb. 19, 2026

(54) METHODS, SYSTEMS, APPARATUSES, AND COMPUTER-READABLE MEDIA FOR TRAINING NEURAL NETWORK TO LEARN COMPUTER CODE CHANGE REPRESENTATIONS

(71) Applicant: HUAWEI TECHNOLOGIES CO., LTD., Shenzhen (CN)

(72) Inventors: Jiayuan Zhou, Kanata (CA); Jinfu Chen, Wuhan (CN); Michael Pacheco, Kanata (CA); Xin Xia, Hangzhou (CN); Yuan Wang, Kanata (CA); Ahmed E. Hassan, Kingston (CA)

(73) Assignee: HUAWEI TECHNOLOGIES CO., LTD., Shenzhen (CN)

(21) Appl. No.: 19/244,309

(22) Filed: Jun. 20, 2025

Related U.S. Application Data
(63) Continuation of application No. PCT/CN2022/141303, filed on Dec. 23, 2022.

(51) Int. Cl. G06N 3/096

(52) U.S. Cl. CPC G06N 3/096

(57) ABSTRACT

There is described a method and a computer-readable medium for training a neural network. A section of computer code is divided into a plurality of computer code parts. A first change sample is generated comprising a first original segment of computer code and a first modified segment of computer code, the first change sample comprising at least one of the plurality of computer code parts. A second change sample is generated comprising a second original segment of computer code and a second modified segment of computer code. A loss function is calculated based on the first change sample and the second change sample. The neural network is trained by minimizing the loss function.

### CROSS-REFERENCE TO RELATED APPLICATION

This application is a continuation application of PCT International Patent Application Ser. No. PCT/CN2022/141303, filed 23 Dec. 2022, the content of which is incorporated herein by reference in its entirety.

### TECHNICAL FIELD

The present disclosure relates generally to methods, systems, apparatuses, and computer-readable storage media for training a neural network, and in particular to methods, systems, apparatuses, and computer-readable storage media for training a neural network to detect and characterize vulnerability fixes in computer code changes.

### BACKGROUND

With software projects there is often a delay between the time of fixing a vulnerability in a software product by the developers thereof and the time the vulnerability is publicly announced or otherwise is known by the public. This time gap provides a window of opportunity for the vulnerability to be exploited. Since open source software commits are public, a malicious party could potentially discover the vulnerability based on the public software commit of the fix before the vulnerability has been announced to the public. There is therefore a need for determining whether a computer code change fixes a vulnerability.

### SUMMARY

Generally, according to some embodiments of the disclosure, there are described methods for training a neural network to detect vulnerability fixes in computer code changes. Response disclosure models for open source software projects may involve the following three steps: (1) the vulnerability is fixed secretly. without mention of the vulnerability; (2) the vulnerability is publicly disclosed via advisories; and (3) users of the software update the software in response to the vulnerability advisory. It is crucial for users of software systems to be aware of vulnerabilities and to update their systems in a timely fashion. In the context of open source software, the vulnerability may be fixed in step (1) via a source code commit to a public source code repository as a silent fix. A silent fix is a commit for fixing a vulnerability that does not include any information about the vulnerability. Nonetheless, it is possible for a malicious user to reverse engineer the vulnerability based on the change to the computer code to fix the vulnerability in step 1. A malicious user could therefore exploit the vulnerability against users of the software that have not yet updated their software. There may be a time gap between step (1) when the vulnerability is fixed and step (2) when the vulnerability is publicly disclosed via an advisory. It is therefore important for users of open source software to detect silent fixes before they are announced publicly. There is therefore a need to for a neural network that can take patch data as input and determine whether the patch is for fixing a vulnerability.

One of the problems facing the creation of such a neural network is the lack of sufficient data for training the neural network. In some embodiments, the computer code data may be augmented to increase the size of the training data. For example, for each function code change, the original computer code may be divided into a plurality of OriFSlices, and the modified computer code may be divided into a plurality of ModFSlices. Control flow graphs and data flow graphs may be used to generate the slices based on a changed variable as an anchor. The OriFSlices and ModFSlices may be combined together into a plurality of function change samples. An automatically generated description may also be included in the sample. Since the OriFSlices and the ModFSlices come from the same changed function, they may have the same semantic meaning. That is, that they fix the same vulnerability. As such, the samples may be used to train a neural network to detect vulnerabilities through contrastive learning in an unsupervised manner, since it is not necessary for a user to label the function changes. The common weakness enumeration (CWE) may be used to assist in the training. The CWE provides a dictionary of common vulnerabilities that may be used to categorize vulnerabilities. Since a single patch may result in a plurality of samples, the available data has been augmented. The neural network may be trained by minimizing the difference between samples from the same function or the same CWE category. The neural network may further be trained by maximizing the distance between samples from different CWE categories.

According to a first aspect of the disclosure, there is described a method for training a neural network, comprising: dividing a section of computer code into a plurality of computer code parts; generating a first change sample; generating a second change sample; calculating a loss function based on the first change sample and the second change sample; and training the neural network by minimizing the loss function.

In a possible implement, wherein first change sample comprising a first original segment of computer code and a first modified segment of computer code.

Optionally, wherein the first original segment and the first modified segment correspond to a same function.

In another possible implement, wherein the plurality of computer code parts comprises a plurality of original computer code parts and a plurality of modified computer code parts, wherein the first original segment of computer code comprises a first one of the plurality of original computer code parts, wherein the first modified segment of computer code comprises a first one of the plurality of modified computer code parts.

In another possible implement, wherein the second change sample comprising a second original segment of computer code and a second modified segment of computer code.

Optionally, wherein the second original segment of computer code comprises a second one of the plurality of original computer code parts, and wherein the second modified segment of computer code comprises a second one of the plurality of modified computer code parts.

In another possible implement, wherein the first change sample and the second change sample correspond to a same function.

Optionally, wherein the first change sample and the second change sample belong to a same category.

In another possible implement, wherein the first change sample and the second change sample both fix a same category of vulnerability.

In another possible implement, wherein the first change sample further comprises an automatically generated description or manually labelled description or combined by automatically generated description and manually labelled description.

Optionally, wherein the section of computer code is a function.

In another possible implement, wherein the function is divided into a plurality of computer code parts based on a changed variable using a control flow graph or a data flow graph.

In another possible implement, further comprising:
generating a third change sample; calculating the loss function from the first change sample and the third change sample; and training the neural network by maximizing the loss function.

In another possible implement, wherein the section of computer code is obtained from a security advisory service or a common vulnerabilities and exposures database.

In another possible implement, wherein the neural network is trained in an unsupervised manner.

In another possible implement, wherein the neural network is trained using contrastive learning, or wherein the neural network is a Siamese neural network.

Optionally, further comprising fine-tuning the neural network for a task.

In another possible implement, wherein the computer code is source code, intermediate code, or machine code.

According to a further aspect of the disclosure, there is provided a non-transitory computer-readable medium comprising computer program code stored thereon for training a neural network, wherein the code, when executed by one or more processors, causes the one or more processors to perform a method comprising: dividing a section of computer code into a plurality of computer code parts; generating a first change sample comprising a first original segment of computer code and a first modified segment of computer code, the first change sample comprising at least one of the plurality of computer code parts; generating a second change sample comprising a second original segment of computer code and a second modified segment of computer code; calculating a loss function based on the first change sample and the second change sample; and training the neural network by minimizing the loss function.

The method may furthermore comprise performing any of the operations described above in connection with the first aspect of the disclosure.

The neural network may be used to calculate a probability that a computer code change fixes a vulnerability. The neural network may be used to calculate a probability that a computer code change belongs to a category. The neural network may be used to assign a rating to a vulnerability. The rating may be an exploitability rating or a severity rating.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

For a more complete understanding of the disclosure, reference is made to the following description and accompanying drawings, in which:

FIG. 1 is a schematic diagram of a computer network system for training a neural network to learn computer code change representations, according to some embodiments of this disclosure;

FIG. 2A is a schematic diagram showing a simplified hardware structure of a computing device of the computer network system shown in FIG. 1;

FIG. 2B is a schematic diagram showing a simplified software architecture of a computing device of the computer network system shown in FIG. 1;

FIG. 3 shows an exemplary timeline of response disclosure;

FIG. 4 shows an example of a commit;

FIG. 5A is a flowchart showing three phases of a method for training a neural network to learn computer code change representations, according to some embodiments of this disclosure;

FIG. 5B is a flow diagram showing some details of the three phases of the method shown in FIG. 5A;

FIG. 6 is a flow diagram of a method for training a neural network to learn computer code change representations, according to some embodiments of this disclosure;

FIG. 7 is a schematic diagram of a method for augmenting computer code change data, according to some embodiments of this disclosure;

FIG. 8 is a schematic diagram of a method for training a neural network to learn computer code change representations, according to some embodiments of this disclosure;

FIG. 9 is schematic diagram of a source code change;

FIG. 10 shows an example of a function change description FCDesc for the patch that fixed a cross-site scripting vulnerability in Apache ActiveMQ; and

FIG. 11 is a flow diagram showing the workflow of downstream task fine-tuning in Phase 3 of the method shown in FIG. 5A.

### DETAILED DESCRIPTION

Embodiments disclosed herein relate to a neural network module or circuitry for executing a neural network training process, and more specifically, a neural network training process for detecting and characterizing vulnerability fixes in computer code changes. Herein, a vulnerability fix is a commit for fixing a vulnerability in a software product such as a vulnerability in an open source software product.

As will be described later in more detail, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As will be described in more detail below, the neural network module may be a part of a device, an apparatus, a system, and/or the like, wherein the neural network module may be coupled to or integrated with other parts of the device, apparatus, or system such that the combination thereof forms the device, apparatus, or system. Alternatively, the neural network module may be implemented as a standalone neural network device or apparatus.

The neural network module executes a neural network training process for training a neural network to learn computer code change representations. Herein, a process has a general meaning equivalent to that of a method, and does not necessarily correspond to the concept of computing process (which is the instance of a computer program being executed). More specifically, a process herein is a defined method implemented using hardware components for processing data (for example, computer code changes, source code changes, intermediate code changes, or machine code changes, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the neural network training process disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The neural network module may read the computer-executable code from the storage devices and execute the computer-executable code to perform the neural network training processes.

Alternatively, the neural network training process disclosed herein may be implemented as one or more hardware structures having necessary electrical and/or optical components, circuits, logic gates, integrated circuit (IC) chips, and/or the like.

### A. System Structure

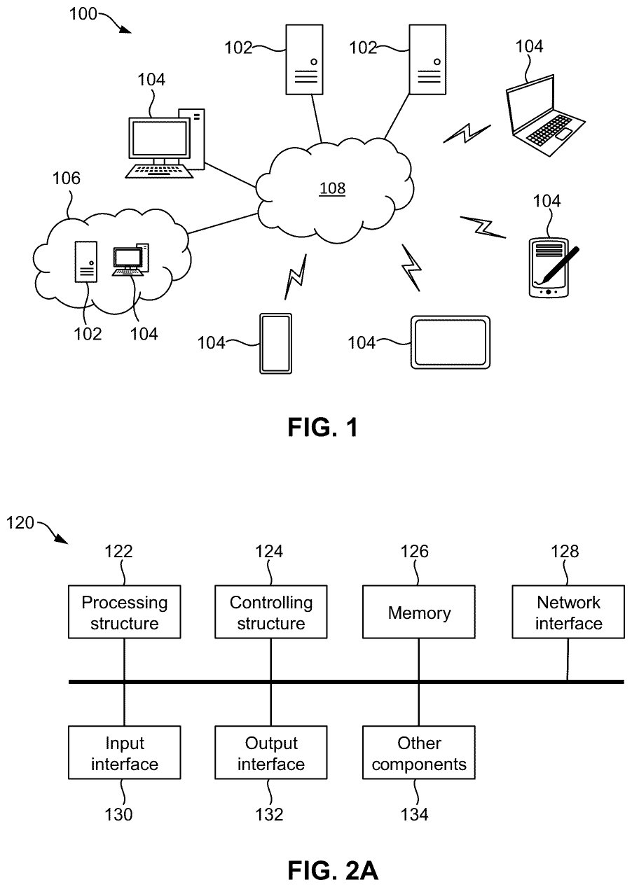

Turning now to FIG. 1, a computer network system for training a neural network is shown and is generally identified using reference numeral 100. In these embodiments, the neural network system 100 is configured for training a neural network.

As shown in FIG. 1, the neural network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

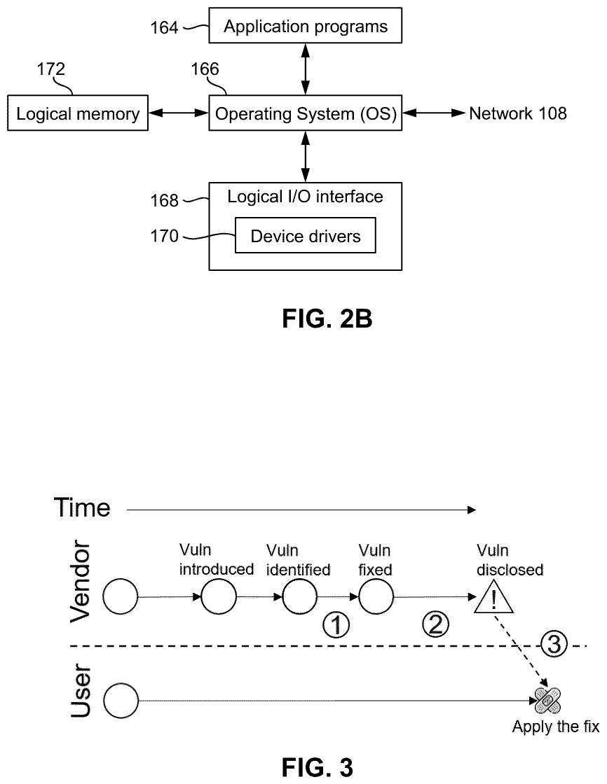

Generally, the computing devices 102 and 104 comprise similar hardware structures such as hardware structure 120 shown in FIG. 2A. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing an encryption process and/or a decryption process, as the design purpose and/or the use case maybe, for encrypting and/or decrypting data received from the input and outputting the resulting encrypted or decrypted data through the output.

For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 1, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

FIG. 2B shows a simplified software architecture 160 of the computing device 102 or 104. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® IOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 of the image-sanitization system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory arca that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory arca. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the neural network system 100 may have the potential to perform various tasks, it cannot perform any tasks and is of no use without meaningful firmware and/or software. As will be described in more detail later, the neural network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Response Disclosure Models

Response disclosure (also called “coordinated vulnerability disclosure”) is a vulnerability disclosure model, in which a vulnerability or an issue is disclosed only after a period of time that allows for the vulnerability or issue to be patched or mended. As shown in FIG. 3, response disclosure models for open source software projects may involve the following three steps: (1) the vulnerability is fixed secretly without mention of the vulnerability; (2) the vulnerability is publicly disclosed via advisories; and (3) users of the software update the software in response to the vulnerability advisory. It is crucial for users of software systems to be aware of vulnerabilities and to update their systems in a timely fashion.

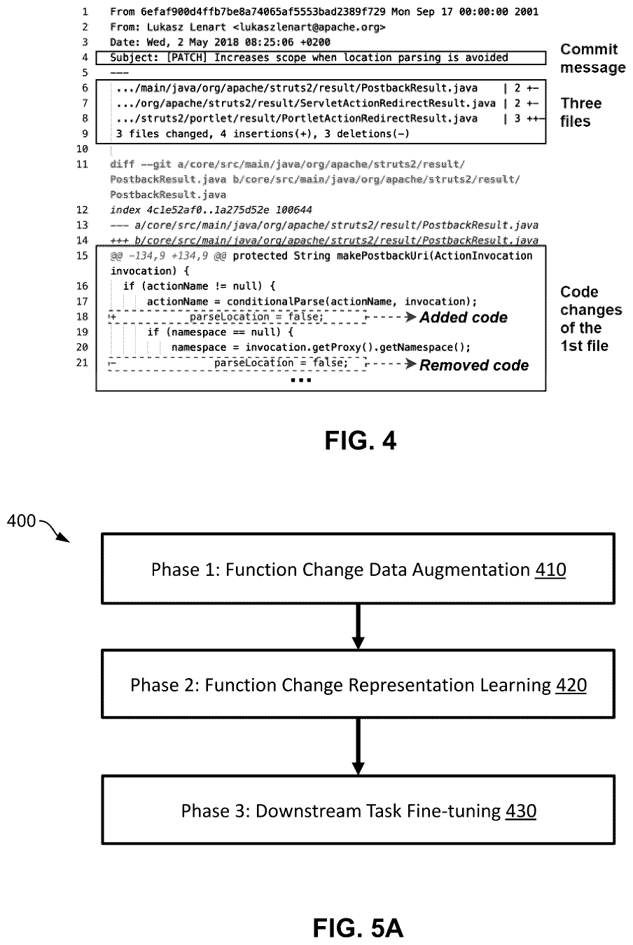

In the context of open source software, the vulnerability may be fixed in step (1) via a source code commit to a public source code repository as a silent fix. Herein, a commit comprises three important pieces of information: (i) the commit message; (ii) the modified file names; and (iii) the code change of each file. FIG. 4 shows an example of a commit having the modified codes, for example, the added code in line 18 and the removed code in line 21. A silent fix is a commit for fixing a vulnerability wherein the fix does not include any information that will indicate the vulnerability. For example, the commit message of the commit will not mention the name or nature of the vulnerability. Nonetheless, it is possible for a malicious user to reverse engineer the vulnerability based on the change to the computer code to fix the vulnerability in step (1). A malicious user could therefore exploit the vulnerability against users who have not yet updated their software.

There may be a time gap between step (1) when the vulnerability is “silently” fixed and step (2) when the vulnerability is publicly disclosed via an advisory. For example, there is often a time gap of around seven to ten days between steps (1) and (2). This time gap creates an opportunity for exploitation by the malicious user. Since in the context of open source software, the source code commits for fixing the vulnerability are public, a malicious party could potentially uncover the vulnerability and exploit it against users of the software during the time gap before the users have been notified of the vulnerability. It is therefore important for users of open source software to detect silent fixes before they are announced publicly.

Moreover, it is not enough to merely identify vulnerability silent fixes. An explanation of the silent fix should also be provided. The users of the software may not be experts on every software they use, and it may be difficult for the user to understand the nature of the vulnerability. If users do not understand the nature of the vulnerability, there is a risk that they will ignore the update, making such an early warning system ineffective. Providing some kind of explanation of the vulnerability is therefore important. For example, a category or exploitability rating may be provided for the vulnerability in order to help users understand and evaluate the vulnerability.

The Common Vulnerabilities and Exposure (CVE) database provides a reference-method for the disclosure, identification, and management of publicly known vulnerabilities. The National Vulnerability Database (NVD) is a popular CVE database that provides enhanced vulnerability information such as Common Weakness Enumeration (CWE). CWE provides a dictionary of common weaknesses that may result in vulnerabilities in software or hardware. They include various details regarding several types of vulnerabilities. A CWE may be used to categorize CVEs, by being assigned to CVEs, which provide additional information about the vulnerability. CVEs may be assigned multiple CWEs depending on the nature of the vulnerability but not every CVE in NVD has a CWE assigned. Providing a CWE to a user for a silent fix may help the user understand the nature of the silent fix.

The Common Vulnerability Scoring System (CVSS) helps define and categorize vulnerabilities based on their potential impact and risk. There are two typical CVSS versions, that is, CVSS 2.0 and 3.0. Exploitability is one of the base group metrics in CVSS, which is used to measure the risk of a vulnerability being exploited. The more easily a vulnerability may be exploited, the higher the exploitability score of this vulnerability. Therefore, the exploitability metric reflects the risk of a vulnerability and allows users to prioritize the vulnerability. For example, the CVSS score may identify a vulnerability as having a low, medium, or high risk. Providing a CVSS score to a user for a silent fix may help the user understand the nature of the silent fix.

There are a number of problems with the traditional methods that users use to monitor for security updates. For example, users may monitor security advisories from services like NVD. However, as already mentioned, because of the response disclosure model there is usually a gap between when the vulnerability is fixed and when it is disclosed. Moreover, many vulnerabilities are never disclosed on NVD. Alternatively, users may monitor the commits to the public source code repository to determine which commits are vulnerability fixes. The problem with this method is that many of the fixes are silent fixes, so there is no mention that the commit is for fixing a vulnerability. Since users are rarely expert in the open source software that they are using, it may be difficult to determine which source code commits are for fixing vulnerabilities. Moreover, any given software project may have many source code commits per day, the majority of which do not relate to fixing vulnerabilities. This further adds to the difficulty of attempting to identify the commits that are for fixing vulnerabilities.

Another solution is to use VulFixMiner. VulFixMiner is a technical solution for identifying vulnerability silent fixes based on commit-level or file-level code changes. VulFixMiner incorporates a deep learning solution designed for analyzing the source code of commits, and then trains a neural network to identify vulnerability fixes. VulFixMiner includes three phases:
1. Fine-tuning Phase: A pre-trained language model is fine tuned to learn the representation of file-level code changes.
2. Training Phase: The fine-tuned model is considered as the file change transformer, collaborating with a commit change aggregator to encode commit-level code changes into commit-level code change representations. Then a neural network classifier is trained to identify commits using the representations.
3. Application Phase: The trained VulFixMiner consumes new commits from open source software repositories and computes scores, which indicate the likelihood that a commit is for fixing a vulnerability.

There are a number of disadvantages to using VulFixMiner. It is challenging to identify silent fixes and provide explanations due to the limited and diverse data. The vast majority of source code commits are not related to vulnerability fixes. There is therefore limited data for training the neural network. Moreover, the fixed vulnerabilities are associated with a wide range of CWE categories, indicating the diverse causes, behaviors, and consequences of vulnerabilities, resulting in diverse patterns of the corresponding fixes. Limited and diverse data for training results in a neural network that does not produce reliable results.

VulFixMiner utilizes the added and removed code snippets from the whole commit to identify silent fixes rather than using function-level changes. A single commit might address different issues. A single commit may for example fix a vulnerability as well as add a feature. Due to the mixed information from the whole commit and the lack of code context information, it is hard for VulFixMiner to provide explanations for diverse fixes. VulFixMiner may be used for identifying vulnerability fixes but not for providing explanations or ratings for those vulnerability fixes.

VulFixMiner requires supervised learning. VulFixMiner requires that the code changes be pre-labeled for it to learn which code changes are vulnerability fixes. VulFixMiner has no way to be trained using unsupervised learning. As a result, it is time-consuming to train VulFixMiner, and less training data can be used to train VulFixMiner, which results in less reliable results. In other words, the two main defects of VulFixMiner is that it has no way of augmenting the limited code change data available or to train the model in an unsupervised manner.

According to some embodiments, contrastive learning is used to train the neural network. Contrastive learning is widely used in Computer Vision and Natural Language Processing (NLP) domains. The key to contrastive learning is data augmentation. By applying augmentation on one data point to generate two samples that are different but semantically similar, contrastive learning tries to learn the similar knowledge within the samples from the same data points, and learn the differences between samples that are generated from different data points. In the NLP domain, for example, data augmentation is accomplished by the manipulation of tokens, for example, token reordering and similar token replacement. In the software engineering domain, prior studies focused on source code. Based on approaches from NLP, prior studies further propose sampling/augmentation strategies based on the compilation mechanism to generate source code samples. For example, they use code compression, identifier modification, and regularization. Such approaches are capable of learning source code representations, but none of them are capable of learning source code change representations.

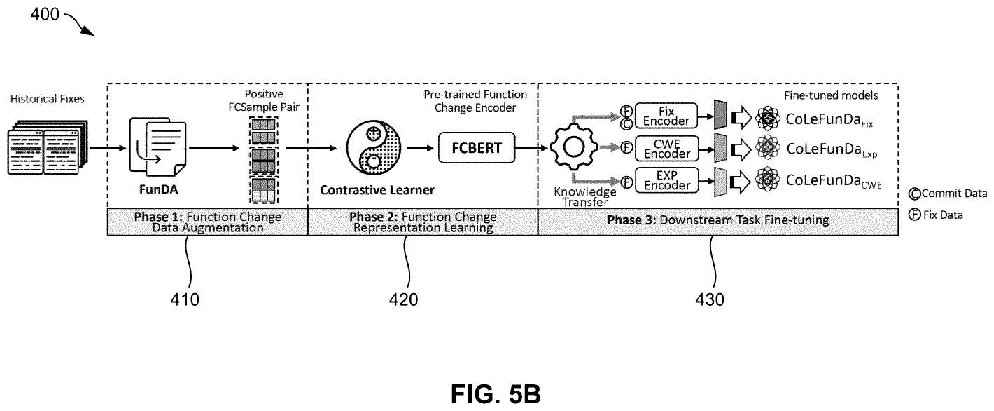

Reference is now made to FIGS. 5A and 5B, which show three phases of a method 400 for training a neural network in accordance with some embodiments of the present disclosure. Phase 1 comprises function change data augmentation 410. In Phase 1, the code change data is increased at the function level. More specifically, Phase 1 combines program slicing techniques and CWE category information to augment function changes with unsupervised (that is, the self-based) and supervised (that is, the group-based) methods. A single function change from a patch or commit is augmented into a set of semantics-preserving function change samples (FCSamples). Every two semantically-similar or functionality-similar FCSamples may be considered as a positive pair for the contrastive learning in the next phase. Phase 2 comprises function change representation learning 420. The contrastive learner learns the representations of diverse fix data effectively by minimizing the distance between positive samples (similar data representations) and maximizing the distance between negative samples (dissimilar data representations). The contrastive learner learns function-level code change representations from diverse fix data and trains the neural network. Phase 3 comprises downstream task fine-tuning 430. In Phase 3, the neural network may be further fine-tuned. In some embodiments, the neural network is fine-tuned to produce a silent fix identification model, a CWE classification model, and an exploitability rating classification model. The approach is applicable for developing other types of models, such as a severity classification model.

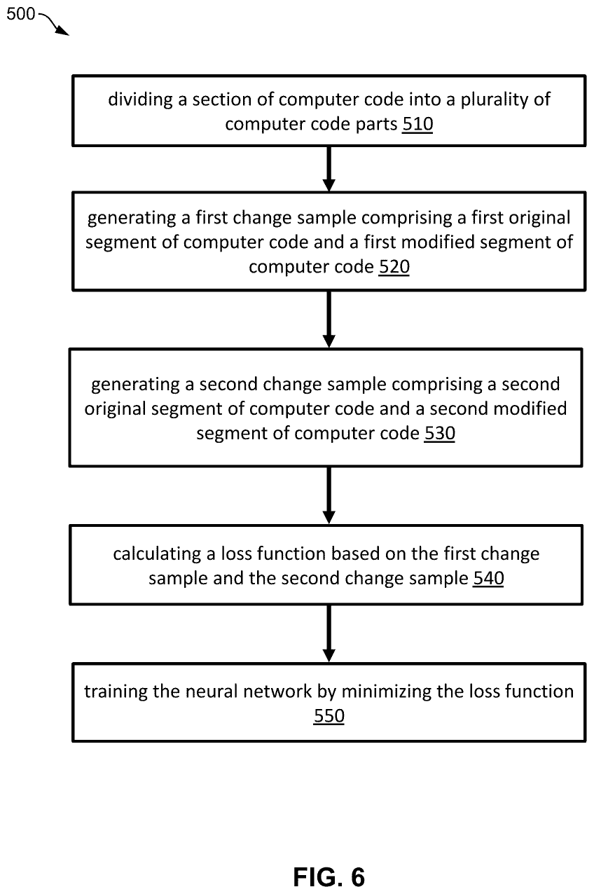

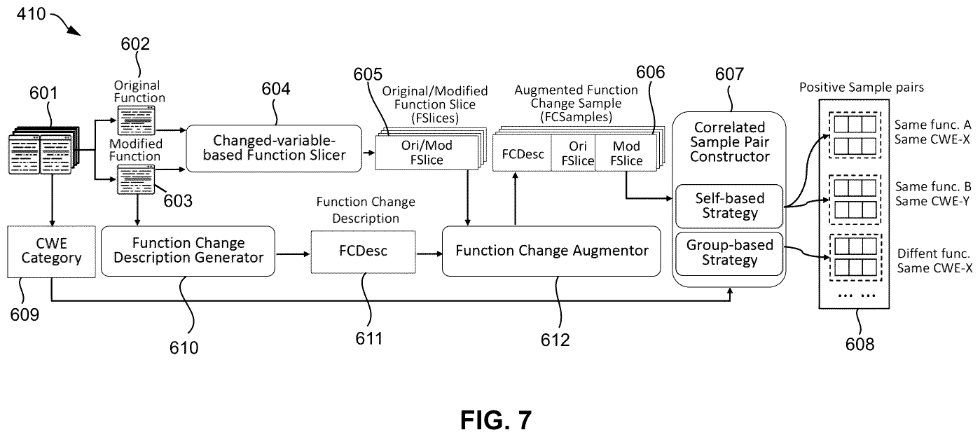

Reference is now made to FIG. 6, which shows a method 500 for training a neural network to learn computer code change representations. Reference is made concurrently to FIG. 7, which shows a schematic diagram of a method for augmenting computer code change data, corresponding to the data augmentation step 410 of Phase 1 of the method 400. The method 500 comprises dividing a section of computer code 601 into a plurality of computer code parts 510. The computer code may be source code, intermediate code, machine code, or any other type of code that may be read, interpreted, or compiled by a computer. In the preferred embodiment, the section of computer code 601 is a function. However, any other section of computer code may be used, such as a file, a class, or a data structure. Dividing the section of computer code 601 into a plurality of computer code parts may comprise using a program slicing module 604 to generate function slices 605 (FSlices) for the original function 602 and modified function 603. The slices 605 correspond to the computer code parts. For each function change, function slices 605 are generated for the original function 602 (OriFSlices) and the modified function 603 (ModFSlices). Since the changed code statements between the original function 602 and modified function 603 fix the same vulnerability, the changed variables in the changed code statement may be used as anchors for slicing. Other anchors may also be used for slicing. The function changes may be represented in a single file using a track changes or diff notation that indicates which lines have been removed and which lines have been added. Alternatively, the function changes may be represented in two files, where one file represents the original computer code, and the other file represents the modified computer code.

The slices 605 may be comprehensive slices 605, which merge aspects of both forward and backward slices. The function may be divided into a plurality of computer code parts or slices based on a changed variable as an anchor using a control flow graph or a data flow graph. Control flow graphs (CFGs) and data flow graphs (DFGs) may be used to generate the slices 605 since the combination of such graphs maintains the structural integrity of the original program, and extracts data relationships between variables in the program. A source code parsing tool, such as TreeSitter, may be used to generate the CFGs and the DFGs. Other types of computer graphs and parsing tools may be used to generate the slices 605. For each anchor, the corresponding code statements from these paths are extracted to create changed-variable based FSlices 605 for the function.

Reference is now made to FIG. 9, which shows a schematic diagram of a function code change. The function code change 801 shows the lines of source code that have been removed and added from the function. The function code change 801 relates to two different variables: “serverId” and “base”. A first OriFSlice 803 shows the slice generated based on the original function using the serverId variable as the anchor. A first ModFSlice 804 shows the slice generated based on the modified function using the serverId variable as the anchor. A second OriFSlice 806 shows the slice generated based on the original function using the base variable as the anchor. A second ModFSlice 807 shows the slice generated based on the modified function using the base variable as the anchor. In other words, this function code change 801 has been used to generate four slices, two original and two modified. Note that not every function change contains a changed variable. For example, some function changes relate to function call renaming or operator changing. In this case, the function has no changed-variable based slices. As such the full function may be used without slicing. In other words, the function change will generate a single OriFSlice and a single ModFSlice.

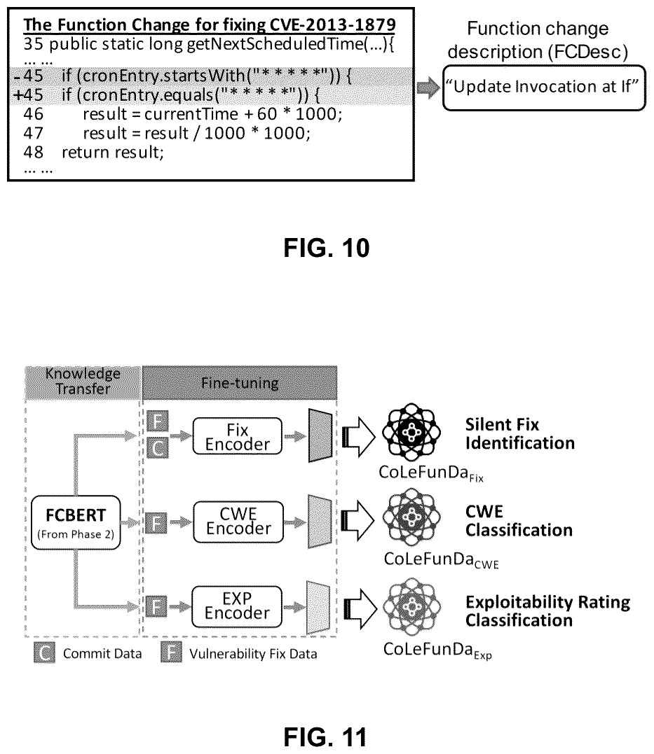

Multi-modal pre-training may help text-based models learn the implicit alignment between inputs of different modalities, for example, between natural language and programming language. The FCSamples 606 may comprise an automatically generated description 611. A function change description 611 (FCDesc) may be included in the sample 606 as complementary information to enhance the augmented function change samples 606. The function change descriptions 611 may be generated using a function change description generator 610, such as GumTree Spoon AST Diff. GumTree generates a list of change operations for each original and modified function pair. The GumTree tool is capable of identifying insert and delete change operations, along with renaming or moving operations, providing detailed information of the change. FIG. 10 shows an example of the FCDesc for the patch that fixed a cross-site scripting vulnerability in Apache ActiveMQ.

The method 500 further comprises generating a first change sample 606 comprising a first original segment of computer code (for example, an OriFSlice) and a first modified segment of computer code (for example, a ModFSlice), the first change sample 606 comprising at least one of the plurality of computer code parts (that is, the first change sample comprises at least one of the generated function slices 605) 520. The method 500 further comprises generating a second change sample comprising a second original segment of computer code (for example, an OriFSlice) and a second modified segment of computer code (for example, a ModFSlice) 530. FCSamples 606 may be constructed for the function change by a function change augmentor module 612 as:

$${FCSample}_{i j} = FCDesc ⊕ OriF {Slice}_{i} ⊕ ModF {Slice}_{j} \qquad ( 1 )$$

where ⊕ is the concatenation operator, “i” and “j” are the i^{th} and the j^{th} OriFSlices and ModFSlices, respectively.

FIG. 9 shows two example FCSamples. The first FCSample 802 comprises the first OriFSlice 803 and the first ModFSlice 804. The second FCSample 805 comprises the second OriFSlice 806 and the second ModFSlice 807. The first original segment and the first modified segment may correspond to a same function. That is, the FCSample 606 may comprises slices generated from the same function. The FCSample 606 does not need to comprise slices with the same variable as anchor. FCSamples 606 may comprise any slices from the same function. For example, there may be an FCSample comprising the first OriFSlice 803 and the second ModFSlice 807. Since the slices come from the same function, they may have the same semantic meaning (that is, they relate to the same computer code fix). Indeed, in some embodiments, slices from the same class, data structure, or file may be combined together in the same samples. The FCDesc 611 for the function change may also be added to the sample 606. This manner of generating FCSamples 606 augments the available data for training the neural network.

The plurality of computer code parts comprises a plurality of original computer code parts (for example, OriFSlices) and a plurality of modified computer code parts (for example, ModFSlices), wherein the first original segment of computer code comprises a first one of the plurality of original computer code parts, wherein the first modified segment of computer code comprises a first one of the plurality of modified computer code parts, wherein the second original segment of computer code comprises a second one of the plurality of original computer code parts, and wherein the second modified segment of computer code comprises a second one of the plurality of modified computer code parts. That is, each FCSample comprises one OriFSlice and one ModFSlice.

A single patch or commit may result in several FCSamples 606 if the commit contains several different function changes. Moreover, a single function change may result in several FCSamples 606 if it contains changes related to different variables. For example, in function code change 801, four different FCSamples 606 may be generated because the changes relate to two different variables: OriFSlice 1+ModFSlice 1, OriFSlice 2+ModFSlice 2, OriFSlice 1+ModFSlice 2, and OriFSlice 2+ModFSlice 1. Compare this to VulFixMiner using an example of a single patch that contains changes to three functions, each with two variable changes. For VulFixMiner, this patch may generate a single training sample. According to the present disclosure, by contrast, this single patch may generate twelve training samples for training the neural network. This data augmentation technique improves the reliability of the trained neural network. To avoid the potential for overfitting, the number of FCSamples 606 from a single function change may be limited. For example, the number of FCSamples 606 from a single function change may be limited to four. The four selected FCSamples 606 may be randomly selected from the total number of FCSamples 606.

In order to train the neural network, the FCSamples 606 may be combined into positive sample pairs by a correlated sample pair constructor module 607. The neural network will then attempt to minimize the difference between the positive sample pairs. With the FCSamples 606, and the CWE category 609 information of each function change (FC_CWE), the correlated sample pair constructor may generate positive FCSample pairs 608. Two FCSamples 606 are a positive function change sample pair if they are correlated (for example, their semantic meanings are similar, or their functionality meanings are similar).

There are two methods for constructing positive sample pairs. A first method is an unsupervised function-based method, which is similar to the general data augmentation technique. With this method, the first change sample and the second change sample correspond to a same function. FCSamples 606 may be combined into a positive sample pair if they were generated from the same data instance. For example, two FCSamples 606 may be combined into a positive sample pair if they were generated from the same function. Other sections of computer code may be used. For example, positive sample pairs may be constructed from FCSamples 606 generated from the same file, class, or data structure. Since the two FCSamples 606 originate from the same function, they may be semantically similar to each other (that is, they fix the same type of vulnerability). If a function change fails to generate multiple FCSamples 606 (for example, because there was no changed variable), it cannot be used in this method.

A second method is a supervised group-based method, which leverages the FC_CWE 609 information of function changes to construct positive pairs. With this method, the first change sample and the second change sample may belong to a same category, category of vulnerability, or more specifically the same CWE category 609. For example, for a group of FCSamples 606 belonging to different function changes which fix the same type of vulnerability (that is, the same FC_CWE 609), the FCSamples 606 within the same group may be functionally similar. Hence, such FCSamples 606 in the same CWE category 609 may be used for creating positive pairs 608. Other labels or groups may be used for grouping the FCSamples 606 other than the FC_CWE 609. In some embodiments, the priority may be put on the first method over the second method, so that the group-based method is only used when a function fails to generate more than one FCSample 606.

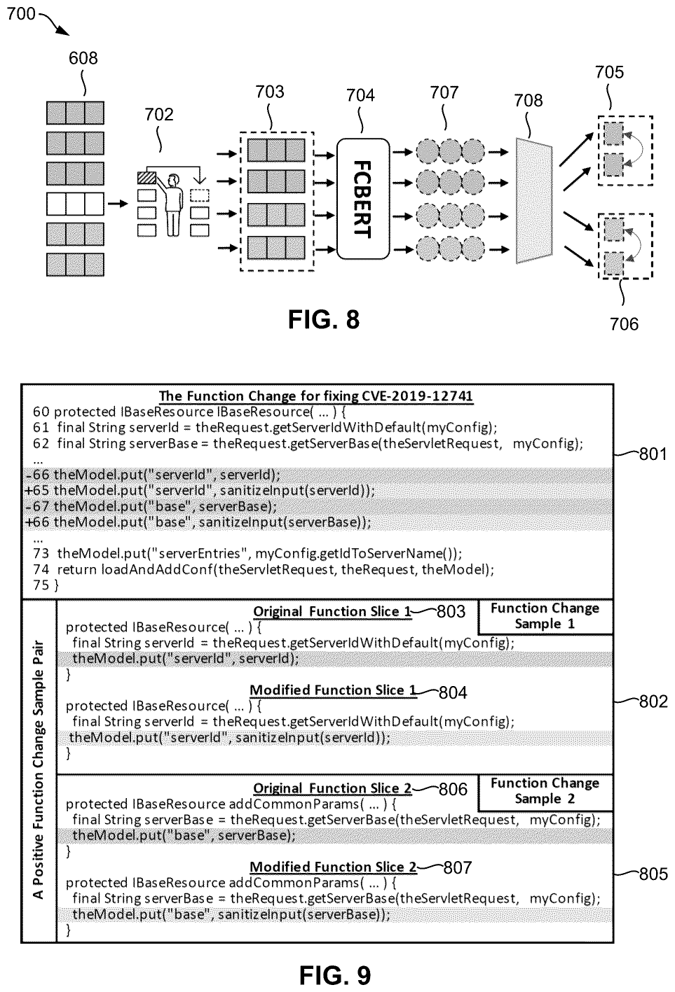

The method 500 further comprises calculating a loss function based on the first change sample and the second change sample 540, and training the neural network by minimizing the loss function 550. Reference is now made to FIG. 8, which shows a schematic diagram of a method 700 for training a neural network to learn computer code change representations, corresponding to the function change representation learning step 420 of Phase 2 of the method 400. To learn the representations of function changes, a contrastive learner may be employed, which may learn data representation effectively by minimizing the distance between similar data (positives) and maximizing the distance between dissimilar data (negatives). Hence, with the constructed positive sample pairs 608, the contrastive learning method may effectively learn the function change representation from diverse vulnerability fixes. A mini-batch arranger 702 may arrange inputs in a mini-batch 703 where all positive pairs within the mini-batch are related to different CWE categories 609. In this way, any samples from one pair are negatively correlated to any samples from other pairs within a mini-batch. Next, we further pre-train an encoder 704 (for example, FCBERT), to encode a function change to its embedding representation vector 707. Then, a projection head 708 maps the vector 707 to the space where a contrastive loss is applied.

The mini-batch arranger 702 arranges n correlated sample pairs from the candidate pairs 608 into a mini-batch 703. The mini-batch arranger utilizes the CWE category 609 to ensure that each of the pairs in a single mini-batch 703 corresponds to different CWE categories 609. That is, sample pair 705 has a different CWE category 609 than sample pair 706. Other methods for distinguishing the semantic meaning or functionality of the sample pairs 608 may be used instead of the CWE category 609.

The pre-trained encoder 704 is used to encode each of the FCSamples 606 in the positive sample pairs 608 to their corresponding function change representation vectors 707. A pre-trained encoder FCBERT 704 with the same architecture and weights as CodeBERT may be used.

A nonlinear projection head 708 helps improve the representation quality of the layer before it. A multilayer perceptron (MLP) with two hidden layers may be used to project the function change representation vector 707 to the space where a contrastive loss is applied.

A contrastive loss function may be defined for maximizing the agreement of samples within the same correlated sample pair, and minimizing the agreement between samples from different sample pairs. According to one embodiment, the Noise Contrastive Estimate (NCE) loss function may be used to compute the loss. For example, the loss function may be minimized between the samples in the same positive sample pair 705, and the loss function may be minimized between the samples in the same positive sample pair 706. The method 500 may further comprise generating a third change sample, calculating the loss function from the first change sample and the third change sample, and training the neural network by maximizing the loss function. That is, the loss function may be maximized between a sample from sample pair 705 and a sample from sample pair 706. Since they belong to different CWE categories 609, they may have different semantic meanings.

The method 500 may further comprise obtaining the section of computer code from a security advisory service or a common vulnerabilities and exposures database (CVE). A common CVE is the NVD. CVE's such as the NVD and security advisory services more generally, publish known software vulnerabilities. CVE's may publish the source code causing the vulnerability or the source code change used to resolve the vulnerability. As such, the source code provided on the CVE may be used for training the neural network to detect silent fixes of vulnerabilities. The source code obtained from the CVE may be downloaded manually and entered into the computer 104. Alternatively, the computer 104 may automatically download the source code from the CVE server 102 over the network 108.

The method 500 may further comprise training the neural network in an unsupervised manner. In some embodiments, the neural network may be trained using contrastive learning. A contrastive learner may learn data representation effectively by minimizing the distance between similar data (positives) and maximizing the distance between dissimilar data (negatives). Since the semantic similarity of the samples 606 is inferred based on the samples 606 originating from the same function, class, or data structure, there is no need for a user to label the samples 606. The neural network may therefore train itself based on the samples 606 in an unsupervised manner without any input or labelling by a user. This reduces the amount of work required to train the neural network, and it increases the amount of training data that may reasonably be used, thus increasing the reliability of the neural network. As another alternative, the neural network may be a Siamese neural network. In fact, any kind of neural network may be used that takes two inputs.

The method 500 may further comprise fine-tuning the neural network for a task, corresponding to the step of downstream task fine-tuning 430 of Phase 3 of the method 400. The encoder FCBERT 704 may be used as a pre-trained model to initialize other fine-tuned encoders by transferring the weights from the pre-trained encoder 704 to the other fined-tuned encoders. For example, as shown in FIG. 11, the encoder 704 may be used to initialize FixEncoder, CWEEncoder, and EXPEncoder.

The goal of the silent fix identification task is to predict the probability that a commit is for fixing a vulnerability. VulFixMiner uses CodeBERT as the pre-trained model to fine-tune the task. CodeBERT in VulFixMiner may be replaced with the FixEncoder. Except for the pre-trained model, the architecture of VulFixMiner may be left unchanged and input construction untouched. The input of the task may be the general commit data and the patch data (that is, the commits that fixed vulnerabilities). For every commit, the neural network outputs a score indicating the probability of the commit for fixing a vulnerability. This neural network may be referred to as CoLeFunDa_fix.

The goal of the CWE classification task is to predict the probability that a given function change in a patch is for fixing a specific CWE category. The input of this fine-tuning task may be the patch data. More specifically, the function change description, the full original function, and the full modified function source code. The input is first encoded into a function change representation vector by CWEEncoder. The vector is then fed into a two-layer neural network to compute probability scores for each CWE category. Note that since one patch may be used for fixing a vulnerability assigned with multiple CWE categories, this task may be considered as a multi-label classification task and employ binary cross entropy as the loss function. This neural network may be referred to as CoLeFunDa_cwe.

The goal of the exploitability rating classification task is to predict the probability of the exploitability rating of the fixed vulnerability. The input and the process of fine-tuning in this task are similar to the CWE classification task, except for the loss function. Since one vulnerability has only one exploitability rating, this task may be considered a multi-class classification task and instead employ cross entropy as the loss function. This neural network may be referred to as CoLeFunDa_exp.

The neural network CoLeFunDa_fix may be used to calculate a probability that a computer code change fixes a vulnerability. Given a set of commits, CoLeFunDa_fix first computes the probability scores and then outputs a list of commits ranked by the predicted probability. The higher the score of a commit indicates the higher chance that the commit fixes a vulnerability.

The neural network CoLeFunDa_cwe may be used to calculate a probability that a computer code change belongs to a category, such as a CWE category. Given a commit that is confirmed for fixing a vulnerability, for each function change within the commit, CoLeFunDa_cwe computes a score for each CWE category as:

$$CW {E}_{j} {Score}_{i} = {CoLeFunDa}_{cwe} ( {FC}_{i} ) \qquad ( 2 )$$

where FCᵢ is the i^{th} function change of the commit, and CWEⱼScoreᵢ is the score of the the j^{th} CWE category. The CWE scores of the commit is calculated as:

$$CW {E}_{j} Score = {max}_{1 ⩽ i ⩽ n} ( {CWE}_{j} {Score}_{i} ) \qquad ( 3 )$$

where n is the number of function changes within the commit. The CWE categories are ranked by scores and the higher score indicates the higher probability of the commit being for fixing that specific category of CWE.

The neural network CoLeFunDa_exp may be used to assign a rating to a vulnerability, such as an exploitability rating or a severity rating. An exploitability rating indicates how easy it is to exploit the vulnerability. A severity rating indicates how bad the consequences may be if the vulnerability is exploited. Given a commit that is confirmed for fixing a vulnerability, for each function change within the commit, CoLeFunDa_exp computes the score for each possible exploitability rating as:

$$E X {P}_{j} {Score}_{i} = {CoLeFunDa}_{exp} ( {FC}_{i} ) \qquad ( 4 )$$

where EXPⱼScoreᵢ is the score of the j^{th} exploitability rating for the i^{th} function change. The commit-level scores of exploitability rating are calculated as:

$$E X {P}_{j} Score = {max}_{1 ⩽ i ⩽ n} ( E X {P}_{j} {Score}_{i} ) \qquad ( 5 )$$

where n is the number of function changes within the commit. The exploitability rating is ranked by scores and the higher score indicates the higher probability of the commit being for fixing a vulnerability rated with that specific exploitability rating. A similar method may be used for calculating a severity rating.

Note that CoLeFunDa_fix, CoLeFunDa_cwe, and CoLeFunDa_exp may be used either separately or sequentially. For better vulnerability early sensing, open source software users may integrate CoLeFunDa_fix, CoLeFunDa_cwe, and CoLeFunDa_exp into an automatic open source software code repository monitoring pipeline. When a new code change is pushed to the public repository, CoLeFunDa_fix may first identify whether the commit is for fixing a vulnerability. If it is, CoLeFunDa_cwe and CoLeFunDa_exp may further provide the explanation regarding the relevant CWE category of the vulnerability together with the exploitability rating.

The neural network learns general function change representations in computer code. This neural network may be used in other applications. For example, the neural network may be used for just-in-time defect prediction in computer code or to generate commit messages for source code commits to a source code repository. Other applications include detecting undisclosed vulnerabilities, summarizing the health of a software project, summarizing release goals, identifying project mentors or experts, generating documentation for a software project, CVE patch matching (that is, identify the patch that fixes a specific CVE), and automated code review. The training method disclosed herein may be used for a wide variety of purposes such as training a function change representation model, training a machine learning model, or training a Generative Adversarial Networks (GAN) model.

The method 500 may be performed by the processor of a client computing device 104. The security advisory service or CVE may be hosted by one or more server computers 102. The client computing device 104 may download the vulnerability information from the CVE server 102 used for training the neural network via the network 108. Another server 102 may host a source code repository, such as GitHub. The client computing device 104 may monitor source code commits to the source code repository server 102 and use the neural network to determine whether the purpose of the source code commit is to fix a vulnerability. The client computing device 102 may thus provide an early warning to the user of the software hosted on the source code repository server that a vulnerability exists. The method 500 may be implemented in several forms, such as a cloud service, a plugin, or a client-end desktop application. The method 500 may also be performed by the processor of a server computer 102.

Although embodiments have been described above with reference to the accompanying drawings, those of skill in the art will appreciate that variations and modifications may be made without departing from the scope thereof as defined by the appended claims.

1. A method for training a neural network, comprising:
dividing a section of computer code into a plurality of computer code parts;
generating a first change sample;
generating a second change sample;
calculating a loss function based on the first change sample and the second change sample; and
training the neural network by minimizing the loss function.

2. The method of claim 1, wherein first change sample comprising a first original segment of computer code and a first modified segment of computer code.

3. The method of claim 2, wherein the first original segment and the first modified segment correspond to a same function.

4. The method of claim 2, wherein the plurality of computer code parts comprises a plurality of original computer code parts and a plurality of modified computer code parts, wherein the first original segment of computer code comprises a first one of the plurality of original computer code parts, wherein the first modified segment of computer code comprises a first one of the plurality of modified computer code parts.

5. The method of claim 1, wherein the second change sample comprising a second original segment of computer code and a second modified segment of computer code.

6. The method of claim 5, wherein the second original segment of computer code comprises a second one of the plurality of original computer code parts, and wherein the second modified segment of computer code comprises a second one of the plurality of modified computer code parts.

7. The method of claim 1, wherein the first change sample and the second change sample correspond to a same function.

8. The method of claim 1, wherein the first change sample and the second change sample belong to a same category.

9. The method of claim 1, wherein the first change sample and the second change sample both fix a same category of vulnerability.

10. The method of claim 1, wherein the first change sample further comprises an automatically generated description or manually labelled description or combined by automatically generated description and manually labelled description.

11. The method of claim 1, wherein the section of computer code is a function.

12. The method of claim 11, wherein the function is divided into a plurality of computer code parts based on a changed variable using a control flow graph or a data flow graph.

13. The method of claim 1, further comprising:
generating a third change sample;
calculating the loss function from the first change sample and the third change sample; and
training the neural network by maximizing the loss function.

14. The method of claim 1, wherein the section of computer code is obtained from a security advisory service or a common vulnerabilities and exposures database.

15. The method of claim 1, wherein the neural network is trained in an unsupervised manner.

16. The method of claim 1, wherein the neural network is trained using contrastive learning, or wherein the neural network is a Siamese neural network.

17. The method of claim 1, further comprising fine-tuning the neural network for a task.

18. The method of claim 1, wherein the computer code is source code, intermediate code, or machine code.

19. One or more processors functionally coupled to one or more non-transitory computer-readable storage media; wherein the one or more non-transitory computer-readable storage media comprise computer-executable instructions; and wherein the instructions, when executed, cause a processing structure to perform the method of claim 1.

20. One or more non-transitory computer-readable storage media comprising computer-executable instructions, wherein the instructions, when executed, cause one or more processors to perform the method of claim 1.
